(19) United States
(12) Patent Application Publication
(10) Pub. No.: US 2026/0349913 A1
(43) Pub. Date: Nov. 5, 2026

(54) ASSISTED DEBUGGING WITH GENERATIVE RESPONSE ENGINE

(71) Applicant: OpenAI OpCo, LLC, San Francisco, CA (US)

(72) Inventors: Bryant Jow, Palo Alto, CA (US); Alexander Christakis, San Francisco, CO (US); Matthew Lim, San Francisco, CA (US); Jessica Liang, New York, NY (US)

(73) Assignee: OpenAI OpCo, LLC, San Francisco, CA (US)

(21) Appl. No.: 19/271,308

(22) Filed: Jul. 16, 2025

Related U.S. Application Data
(60) Provisional application No. 63/800,241, filed on May 5, 2025.

(51) Int. Cl. G06F 11/3698; G06F 8/75

(52) U.S. Cl. CPC G06F 11/3698; G06F 8/75

(57) ABSTRACT

Disclosed are systems, apparatuses, processes, and computer-readable media for assisted debugging using a generative response engine. The present technology relates to an online development environment and debugging with a generative response engine. A method of the present technology includes displaying a user interface at a client device configured to generate a bespoke application with a generative response engine; detecting an application error based on executing the bespoke application, wherein the application error includes a stack trace with line numbers identifying a call order of functions of the bespoke application; providing a debug prompt to a generative response engine that includes information associated with the application error; receiving a response from the generative response engine including a suggestion to resolve the application error; and displaying an interface including the suggestion to resolve the application error.

### CROSS-REFERENCE TO RELATED APPLICATIONS

This application claims the benefit of priority to U.S. provisional application No. 63/800,241, filed on May 5, 2025, entitled “ASSISTED DEBUGGING WITH GENERATIVE RESPONSE ENGINE”, which is expressly incorporated by reference herein in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the present disclosure;

FIG. 2 is a conceptual block diagram of a development application integrated with a generative response engine in accordance with some aspects of the disclosure;

FIG. 3 is an illustration of a development application and corresponding features in accordance with some aspects of the disclosure;

FIG. 4 is an illustration of a development application and thrown exceptions logged into a console in accordance with some aspects of the disclosure;

FIG. 5 is an illustration of a development application and an interface to resolve thrown exceptions using a generative response engine in accordance with some aspects of the disclosure;

FIG. 6 is a flow diagram of a process for assisted debugging using a generative response engine in accordance with some aspects of the disclosure;

FIG. 7 is a conceptual illustration of a stack trace provided by a thrown exception illustrating mapping data in accordance with some aspects of the disclosure;

FIG. 8 is a conceptual diagram illustrating mapping a thrown exception to features in a debug prompt in accordance with some aspects of the disclosure;

FIG. 9 is a flow diagram of a process for assisted debugging using a generative response engine in accordance with some aspects of the disclosure;

FIG. 10 is a flow diagram of another process for assisted debugging using a generative response engine in accordance with some aspects of the disclosure

FIG. 11 is a block diagram illustrating an example machine learning platform for implementing various aspects of this disclosure in accordance with some aspects of the present disclosure;

FIG. 12A, FIG. 12B, and FIG. 12C illustrates an example transformer architecture in accordance with some aspects of the present disclosure; and

FIG. 13 shows an example of a computing system that can implement various aspects of the present disclosure and any engine illustrated in FIG. 1 or any component thereof.

### DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Generative response engines are transforming software development by providing instant, context-aware assistance across the entire development lifecycle. These tools can explain complex code, generate boilerplate, and even suggest architectural improvements in real time and reduce the cognitive load on developers. Generative response engines that can understand natural language and translate inputs into functional code is useful for prototyping, exploring unfamiliar libraries, or rapidly iterating on features. Moreover, by offering intelligent suggestions and learning from user interactions, generative response engines streamline workflows and enable developers to focus more on creativity and problem-solving rather than repetitive tasks.

Generative response engines are useful with web applications, which are software programs that run in a web browser and provide interactive and dynamic experiences without installation. Web applications are generally a part of a technology stack including a server and storage mechanisms that were introduced based on advances in web technologies like hypertext markup language (HTML), cascading style sheets (CSS), and JavaScript. Unlike traditional desktop applications, web apps are accessible from any device with an internet connection, making them highly versatile and platform-independent. Asynchronous JavaScript and extensible markup language (XML) (commonly referred to as Web 2.0) enabled asynchronous data loading, allowing pages to update content dynamically without needing a full reload, greatly enhancing user experience and interactivity. Modern web applications use a bundler (e.g., Webpack) or a development server (e.g., Vite) that takes various assets (e.g., JavaScript, CSS, and images) and combines the assets into optimized files for efficient loading in a web application. Web applications also include a variety of rendering strategies that have various issues (e.g., pure client side apps have poor indexing for search engines, server side apps have increased architectural complexity, etc.).

Online integrated development environments (IDE) were developed to help developers build and share web applications using various technologies such as webassembly, TypeScript, and so forth. Online IDEs create virtualized environments that allow instant project creation, real-time previews, and easy sharing. Online IDEs also allow rapid testing of libraries, third-party services, and many other features. For example, a person can easily test a package without worrying about cumbersome package management issues associated with local development (e.g., installing libraries locally on a development computer). These features make online IDEs ideal for rapid prototyping, education, and collaboration by streamlining the development process and removing setup barriers.

Development within an online IDE is still difficult for novice users. Debugging exceptions can be especially challenging for novice users because the exception often requires understanding abstract concepts like stack traces, error propagation, and the underlying logic of the code. When an exception occurs (e.g., is thrown), the error message may be cryptic or point to a line of code that doesn't clearly reveal the root cause and can lead to confusion and frustration. Novices may not yet have the mental model to trace the flow of execution or identify off-by-one errors, null references, or type mismatches. Additionally, distinguishing between syntax errors, runtime exceptions, and logical bugs requires experience, and without proper tools or guidance, novices may resort to trial-and-error fixes that introduce new problems or mask the original issue.

Systems, apparatuses, processes (also referred to as methods), and computer-readable media (collectively referred to as “systems and techniques”) are described herein for assisted debugging using a generative response engine. For example, a computing device may display a user interface configured to generate a bespoke application with a generative response engine and detect an application error based on executing the bespoke application. The application error includes a stack trace with line numbers identifying a call order of functions of the bespoke application. In some aspects, the computing device (or another computing device such as a server) can map the line numbers to mapping information that maps a call order to information that is understandable by the generative response engine (e.g., vectors). In this context, the generative response engine can learn the mappings between the call stack and features in the code to infer how to resolve the thrown exception.

In some aspects, the generative response engine first provides a suggestion to solve the error. When a user accepts the suggestion, the computing device sends another prompt to the generative response engine with the suggestion. The suggestions provide a hint to facilitate the generative response engine to reason to resolve the error.

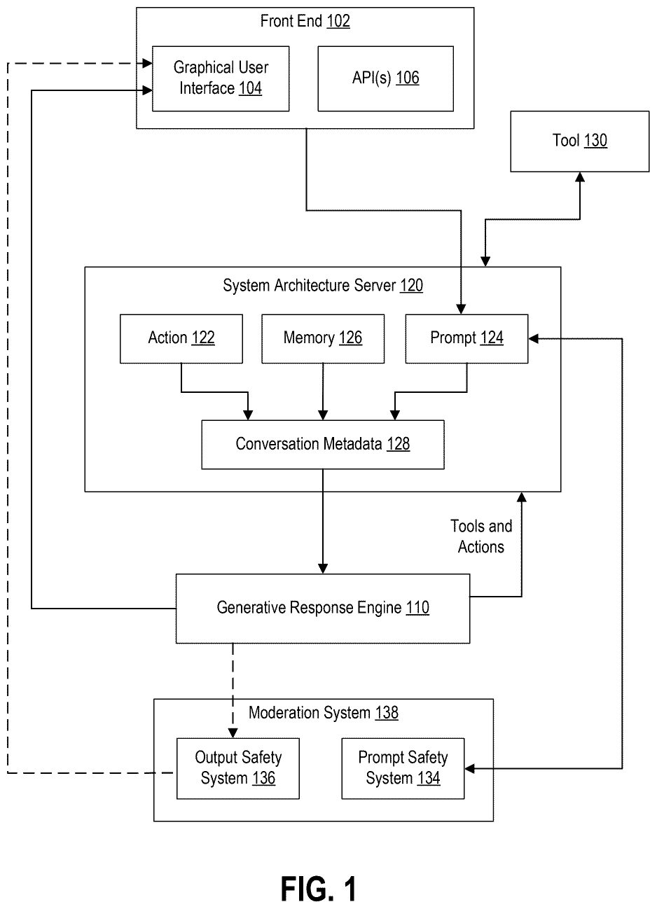

FIG. 1 illustrates an example AI assistant service supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., autoregressive transformer architecture) and combinations of models.

In some instances, a language model, such as CHATGPT, can receive prompts to output images, video, code, applications, etc., which it can provide by interfacing with one or more other models, as will be addressed further herein.

Users and applications can interact with generative response engine 110 through front end 102. The front end 102 serves as the interface and intermediary between the user and the generative response engine. It encompasses the graphical user interface 104 and Application Programming Interfaces (APIs) 106 that facilitate communication, input processing, and output presentation. Generally, users interact through a graphical user interface 104 that often includes a conversational interface, and applications interact through the API 106, but this is not a requirement.

The graphical user interface 104 is the platform through which users interact with the generative response engine 110. It can be a web-based chat window, a mobile application, or any interface that supports data input and output. The graphical user interface 104 facilitates a conversation between the user and the generative response engine, as the user provides prompts in the graphical user interface 104 to which the generative response engine responds and presents those responses in the graphical user interface 104. In some aspects, graphical user interface 104 presents a conversational interface, which has attributes of a conversation thread between a user account and generative response engine 110.

The graphical user interface 104 is configured to perform input handling, context management, and output presentation. The type of inputs that can be received can be relative to the specifics of the generative response engine 110. For example, a language model is generally configured to accept text, but when the generative response engine is a multi-modal generative response engine, the front end 102 can accept voice and images/video.

In some aspects, front end 102 can be an interface to accept any input types as part of the prompt, and downstream services can determine which generative response engine or collection of generative response engines is best suited to respond to the prompt.

The graphical user interface 104 is also configured to maintain the context of the conversation, which allows for coherent and relevant responses. For example, the graphical user interface 104 is responsible for providing the conversation thread and other relevant context accessible to the front end 102 to the generative response engine along with the specific prompt to the generative response engine. In an example, a conversation between the user account and the generative response engine 110 can have taken several turns (prompt, response, prompt, response, etc.). When the user account provides a further prompt, the graphical user interface 104 can provide that prompt to the generative response engine in the context of the entire conversation.

In another example, the graphical user interface 104 might be configured to provide a system prompt along with a user-provided prompt. A system prompt is hidden from the user account and is used to set the behavior and guidelines for the generative response engine. It can be used to define the AI's persona, style, and constraints. There can be levels of system prompts. A highest level of a system prompt might be provided by the generative response engine 110 provider and is meant to establish policies for the behavior of generative response engine 110. This highest level system prompt is prohibited from being edited. A customization system prompt can be used to customize the behavior of the generative response engine and is often provided through an API call, or provided by a user account when creating a customized version of generative response engine 110. A still lower level of system prompt might include hidden information about a task. This can include chain-of-thought from a reasoning model, or context about an application the generative response engine 110 is working with to complete a task. Accordingly, the graphical user interface 104 does not always display all of the output of the generative response engine.

The graphical user interface 104 is also configured to display the responses from the generative response engine, which might include text, code snippets, images, or interactive elements.

In some aspects, the generative response engine 110 can provide instructions to the front end 102 that instruct the graphical user interface 104 about how to display some of the output from the generative response engine. For example, the generative response engine can direct the graphical user interface 104 to present code in a code-specific format, or to present interactive graphics, or static images. In other examples, the generative response engine can direct the graphical user interface 104 to present an interactive document editor where the graphical user interface 104 can be presented with the document editor so that the user account and the generative response engine can collaborate on the document.

In some aspects, the generative response engine 110 can provide instructions memory 126 to record facts in a personalization notepad, and front end 102 can be configured to notify the user account that a memory was created.

As noted above, the front end 102 can also provide one or more application programming interfaces (API(s)) 106. APIs enable developers to integrate the generative response engine's capabilities into external applications and services. They provide programmatic access to the generative response engine, allowing for customized interactions and functionalities. While APIs 106 are shown as part of a front end 102, this illustration takes the liberty of locating API 106 in front end 102 to refer to points of access to generative response engine 110 (i.e., graphical user interface 104 and APIs 106 are points of access and generative response engine 110 sends and receives messages to them in similar ways). In reality, API 106 endpoints are located at context management service 120.

The APIs 106 can accept structured requests containing prompts, context, and configuration parameters. For example, an API can be used to provide prompts and divide the prompt into system prompts and user prompts. In some aspects, the APIs 106 can provide specific inputs for which the generative response engine 110 is configured to respond with a specific behavior. For example, an API can be used to specify that it receives an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that the generative response engine 110 might be trained to interpret. For example, the moderation API can take advantage of the AI assistant service 100's content moderation decision-making. In the case of the moderation API and others, the API might give access to services other than the generative response engine. For example, the moderation API might be an interface to moderation system 138, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might use other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 104 and the APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a context management service 120. The function of context management service 120 is to manage and organize the flow of data among key subsystems, enabling the generative response engine 110 to generate responses that are contextually relevant, accurate, and enriched with additional information.

Action 122 facilitates auxiliary tasks that extend beyond basic text generation. In some aspects, action 122 can be actions that correspond to an API 106. In some aspects, action 122 can be agentic actions that the generative response engine 110 decides to take to carry out a user's intent as described in the prompt. For example, an action can be to call tool 130 or even another generative response engine 110.

Prompt 124 is the request or command provided by the user account through front end 102. In some aspects, prompt 124 can be further supplemented by a system prompt and other information that might be included by graphical user interface 104 or API 106 or associated with a custom generative response engine 110. In some aspects, prompt 124 can even be modified or enhanced by generative response engine 110 as addressed further below. Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. The actors in the conversation thread can be labeled so that generative response engine 110 can review the turns of the conversation. Generally, prompt 124 will include an entire conversation thread, but in some instances, prompt 124 can be shortened if it exceeds a maximum accepted length (generally measured by a number of tokens).

Context management service 120 can also route prompts and response through moderation system 138. In some aspects, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some aspects, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some aspects, memory can be recorded at the instruction of generative response engine 110 when generative response engine 110 identifies a fact or data that it determines should be saved in memory because it might be useful in later conversations or sessions. In some aspects, memory 126 can also include synthesized concepts extracted from past conversation threads, and memory 126 can also encompass the ability of generative response engine 110 to search through past interactions to find relevant information to a current conversation thread.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from context management service 120) and generates outputs. In some aspects, the generative response engine is a generative transformer, or autoregressive transformer, but it could utilize other architectures. In some examples, the transformer is multi-modal transformer that can use audio tokens (or embeddings thereof), visual tokens (or embeddings thereof), and language (or embeddings thereof) as needed.

A core feature of the generative response engine 110 is to generate content in response to prompts. The generative response engine 110 is configured to receive inputs from front end 102 that provide guidance on a desired output. The generative response engine can analyze the input and identify relevant patterns and associations in the data, and it has learned to generate a sequence of tokens that are predicted as the most likely continuation of the input. The generative response engine 110 generates responses by sampling from the probability distribution of possible tokens, guided by the patterns observed during its training. Two features of the autoregressive transformer that result in this functionality are that the autoregressive transformer might use only the decoder part of the transformer architecture and that it utilizes self-attention. By utilizing the decoder part of the transformer architecture, the transformer focuses on predicting the tokens given the previous context tokens. And the self-attention mechanism captures long-range dependencies amongst tokens, allowing it to generate contextually relevant responses (in text, audio, images, and video).

In some aspects, the generative response engine 110 can generate multiple possible responses before presenting the final one. The generative response engine 110 can generate multiple responses based on the input, and these responses are variations that the generative response engine 110 considers potentially relevant and coherent.

In some aspects, the generative response engine 110 can evaluate generated responses based on certain criteria. These criteria can include relevance to the prompt, coherence, fluency, and sometimes adherence to specific guidelines or rules, depending on the application. Based on this evaluation, the generative response engine 110 can select the most appropriate response. This selection is typically the one that scores highest on the set criteria, balancing factors like relevance, informativeness, coherence, and content moderation instructions/training.

In some aspects, an instruction provided by an API 106, a system prompt, or a decision made by generative response engine 110 can cause the generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

The generative response engine 110 can also do more than generate content in response to a prompt. In some aspects, the generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it should interface with another AI model or application to respond to the prompt. For example, when the generative response engine is a language model, it might recognize that it is being asked to output an image, and therefore, it interfaces with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ), and the generative response engine can utilize a decision boundary to recognize that it should plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, the generative response engine 110 might call a tool 130 or cause an action 122 to be performed. As indicated above, tools 130 can include internet browsers, editors such as code editors, other AI tools etc. Actions 122 are actions that the generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that the generative response engine 110 can control the computer operating system on the user's behalf, to robotic actuators, to search browsers and specific applications.

Additionally, the generative response engine 110 can also generate portions of responses that are not displayed to the user. For example, the generative response engine 110 can direct the front end 102 to provide specific behaviors, such as directions for how to present the response from the generative response engine 110 to the user account. In another example, the generative response engine 110 can provide response portions dictated by an API, where portions of the response to the API might be for the consumption of the calling application but not for presentation to the end user. In another example, some generative response engine 110 are reasoning models, which are generative response engine 110 that are configured to output a raw chain-of-thought before preparing a final response to a prompt. The raw chain-of-thought might not be presented to a user account or application calling an API. Instead, another generative response engine 110 might summarize the raw chain-of-thought into a more consumable and useful output for the user account or application.

In some aspects, the output of generative response engine can be further analyzed by output safety system 136. While generative response engine 110 can perform some of its own moderation, there can be instances where it is desired to have another service review outputs for compliance with the moderation policy. The use of dashed lines in FIG. 1 differentiates a path using output safety system 136 and not using output safety system 136.

While FIG. 1 shows responses being provided back to front end 102 directly, in some aspects, the responses might be returned by way of context management service 120.

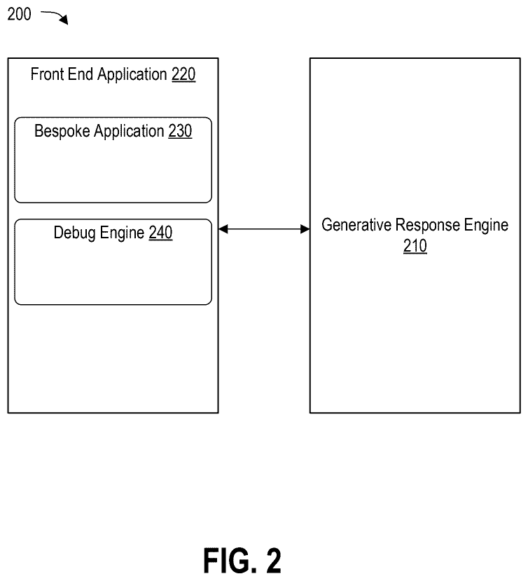

FIG. 2 is a conceptual block diagram of an interactive application development system 200 integrated with a generative response engine 210 in accordance with some aspects of the disclosure. In some aspects, a front end application 220 is rendered by a client device (e.g., a user's device) or a server of generative response engine 210 and configures a client device to interact with generative response engine 210. For example, front end application 220 may include a chat interface that connects to an API of generative response engine 210 to allow interactions.

In some aspects, generative response engine 210 may include features of a bespoke application 230 (e.g., source code) that is scoped within interactive application development system 200 to assist in writing code, markup, configurations, and other relevant information. For example, prompts to generative response engine 210 can include source code, and generative response engine 210 can respond with a combination of natural language and source code to assist a user in writing code associated with a bespoke application 230.

In some cases, front end application 220 may include online development features that include file management (e.g., source code, markup, configurations, etc.), package management (e.g., installation of features), the scaffolding of a basic application (e.g., using a templated application that includes basic structure), and other features to enable interaction with bespoke application 230. In such a case, generative response engine 210 may also include a runtime that limits the scope of bespoke application 230 and isolates its operation from front end application 220.

The front end application 220 may also include a debug engine 240 that is configured to interact with generative response engine 210 to assist users in resolving issues. For example, bespoke application 230 can output errors via a console (e.g., standard output STDOUT, standard error STDERR, etc.). Front end application 220 may intercept the errors of front end application 220 and provide the errors to debug engine 240 to facilitate debugging using generative response engine 210. For example, Table 1 below illustrates an example that imports an entry point (app) of bespoke application 230, imports a spawn function of a protected runtime module, and a function to prompt a generative response engine for debug suggestions (getAiDebugSuggestions). The spawn function is wrapped in a try/catch block to catch errors, and the caught errors are then provided to generative response engine 210 via the getAiDebugSuggestions function.

```
TABLE 1
import { app } from interactiveApp230;
import { spawn } from “@protectedRuntimeModule”
import { getAiDebugSuggestions } from “@debugModule”
try {
  spawn(app( ))
}
catch(e: Error) {
  let response = getAiDebugSuggestions(e) //use AI to get suggestions
  ...
}
```

Table 1 is a simple example, and other permutations are possible. For example, the application can throw the error via a console that is monitored by bespoke application 230, and upon detection of the thrown error in the console, can execute debug functions such as getAiDebugSuggestions( ).

In some aspects, debug engine 240 is configured to generate map information that maps the stack trace of the exception to symbols or other corresponding features in the code. Line numbers are human readable and can be used by a person, but the generative response engine cannot count line numbers to understand where the error is occurring. Mapping information in native form can allow the generative response engine to perform additional actions, such as invoking external functions during inference. For example, the generative response engine can invoke a static analysis of the code to identify syntax errors within the code, identify a scope, and so forth.

Debug engine 240, to map the information, may generate structured information (e.g., a JavaScript object notation (JSON) object) and send the JSON object with the code to generative response engine 210 (e.g., in a prompt). In this way, the generative response engine 210 can map line numbers to the code, invoke external functions when needed, and provide better context to the generative response engine. Generative response engine 210 understands natural language but is also able to understand structured information such as JSON objects. Blending both natural language instruction and structured information provides more specific instructions and enables generative response engine 210 to infer with higher fidelity.

In some aspects, debug engine 240 is also configured to distinguish between a source of the error. For example, debug engine 240 determines whether the user created the error or generative response engine generated the error. Generative response engine 210 may introduce an error based on invalid or unexpected code such as calling a function that doesn't exist or passing the wrong data type. These issues can lead to runtime errors, which are then captured in the stack trace. Generative response engine 210 may also misunderstand a type of data, such as a property of an object that is optional. A user may introduce an error by providing inputs the system doesn't anticipate such as malformed data, unexpected commands, or incorrect formats. If the program doesn't validate or sanitize user input properly, the user input can trigger bugs that also appear in the stack trace.

The debug engine 240 can resolve the sources of errors differently and based on the identification of changes. For example, when front end application 220 may receive a patch from generative response engine 210 to modify bespoke application 230 based on a merge command (e.g., git merge). Based on applying the patch, debug engine 240 can detect the exception and may automatically request generative response engine 210 to address the exception based on the last patch. In this way, debug engine 240 can facilitate development based on the scope of bespoke application 230 that generative response engine 210 understands.

In some aspects, a patch is used to merge changes, unmerging changes, and so forth. A patch may be a diff (e.g., using the longest common subsequence) of different files that identify features that have changed. The patch may also include a dependency graph to map the changes associated with the diff. In some cases, the patch may include an identification of a module to check for conflicts, conflict resolution, etc. Front end application 220 is configured to allow these edits to be tracked, compared, and merged selectively or sequentially with the patches to ensure that updates are integrated without overwriting or conflicting with each other.

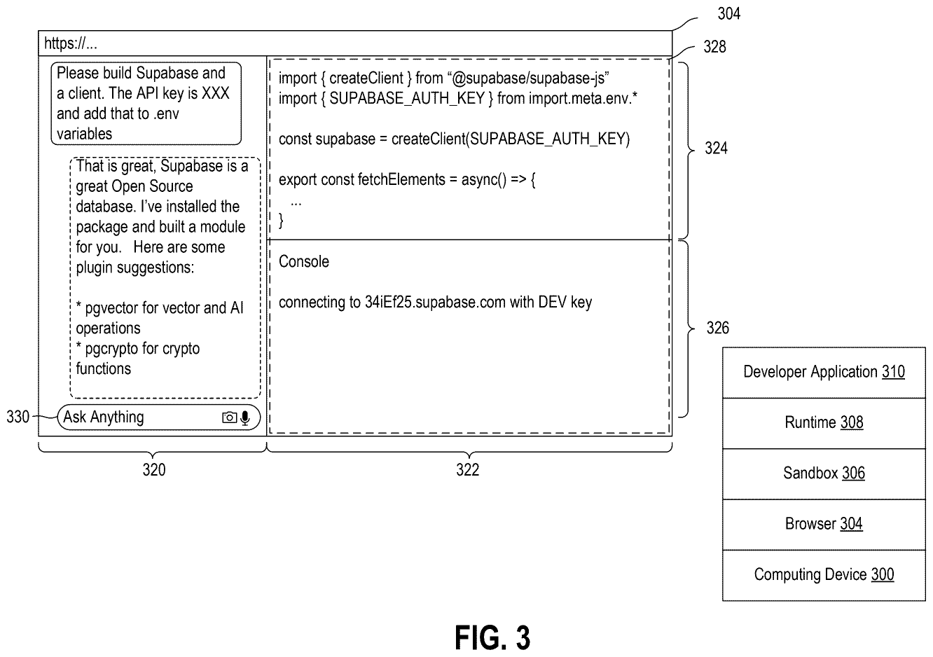

FIG. 3 is a conceptual illustration of a computing device 300 executing a development application in accordance with some aspects of the disclosure. In some aspects, computing device 300 and corresponding features are illustrated as a stack. A stack is a combination of technologies (e.g., hardware and software) that are used together to build and run a software application. Higher layers of the stack depend on the lower layers. For example, the client device includes a processor that executes instructions to execute the browser, and browser 306 includes a sandbox to isolate and secure aspects of a runtime 308, and runtime 308 executes an application 310 (e.g., front end application 220). In some cases, developer application 310 may also be referred to as a development application or an online development environment).

In one aspect, an application 310 (e.g., a web application), can be rendered using various techniques that differ in performance, user experience, and scalability. For example, server-side rendering (SSR) generates the HTML for a page on the server and sends it to the browser, improving initial load times and search engine optimization (SEO) by delivering fully rendered content upfront. In contrast, client-side rendering (CSR) loads a minimal HTML shell and uses JavaScript to fetch and render content dynamically in the browser, which allows for highly interactive interfaces but may lead to slower initial page loads and poor SEO performance. A hybrid approach, often called client-side assembly (CSA) or hydration, combines these methods by rendering static or partial content on the server and enhancing it on the client side with interactivity. In general, mixed-render techniques such as SSR front-load minimal content to reduce the first contentful paint (FCP), which is when the user sees something useful for the first time. Developer application 310 can then request browser 304 to load the (e.g., icons, modules, etc.) without blocking the user interface. Non-web applications can also use these types of rendering techniques, for example by integrating a webview component or using a native webview to render the application (e.g., Electron, Xamarin, .net Maui, etc.).

In some aspects, an application 310 is a front end (e.g., front end 102) to allow interaction with generative response engine (e.g., generative response engine 110) via a user interface. In some aspects, developer application 310 can be configured in various ways to allow content to be presented in an intuitive manner, such as a chat interface. Development of code is better with a more specific interface because additional complexity and context, such as code, and developer application 310 can render a side area 320 for a chat-based interface with the generative response engine and a main area 322 for features pertaining to development. The main area can include a code region 324 and a console 326 that provides information provided by various aspects of the system, such as a development server (if used), developer application 310, etc. Console 326 provides information from developer application 310 (e.g., via a console.log( ) command) or from other aspects, such as exceptions thrown by developer application 310. An exception can include a stack trace which identifies a call stack that invoked the exception. The error is not necessarily associated with the except stack trace, but the stack trace provides hints that can be used to deduce the error itself.

Although not shown, online development environments such as developer application 310 can include local servers to allow more complex development in some cases (e.g., typically using virtualization). For example, a container can be invoked that isolates child processes, such as a process of an application being developed by application 310.

In some aspects, main area 322 is associated with a sandbox 328 that provides a location to render a development interface and limits access to features outside of its scope. For example, sandbox 328 can be an <iframe> and have a separate runtime (e.g., within browser 306) that limits its scope and cannot access outside interfaces other than through APIs of browser 304. For example, as shown in FIG. 3, sandbox 328 may be able to connect to an outside resource using a library that implements APIs of browser 304 (e.g., fetch).

The user can interact with code region 324 to create, edit, and execute code directly within browser 304 without having to install the necessary tools. In some cases, developer application 310 can include a render feature to render the application to allow interactive tweaks to user interfaces and style previews. The interactive features of developer application 310 allow users to rapidly prototype concepts without introducing potentially breaking changes or polluting code with tests and experiments.

In some aspects, side area 320 can include a prompt input 330 to allow the user to input information and interact with the generative response engine to perform various tasks. For example, as shown in side area 320, the user has requested the generative response engine to add a database (e.g., Supabase) and a few parameters (e.g., add the API key to the environment variables, or .env files). The generative response engine then responds with instructions and developer application 310 is configured to perform instructions by the generative response engine. For example, in FIG. 3, the developer application 310 installs a library (supabase), generates a code file (e.g., in code region 324 and associated with a bespoke application), and inserts initial instructions into the code file. Developer application 310 can also modify an appropriate file to include the API key to maintain a strict separation of concerns between code and data.

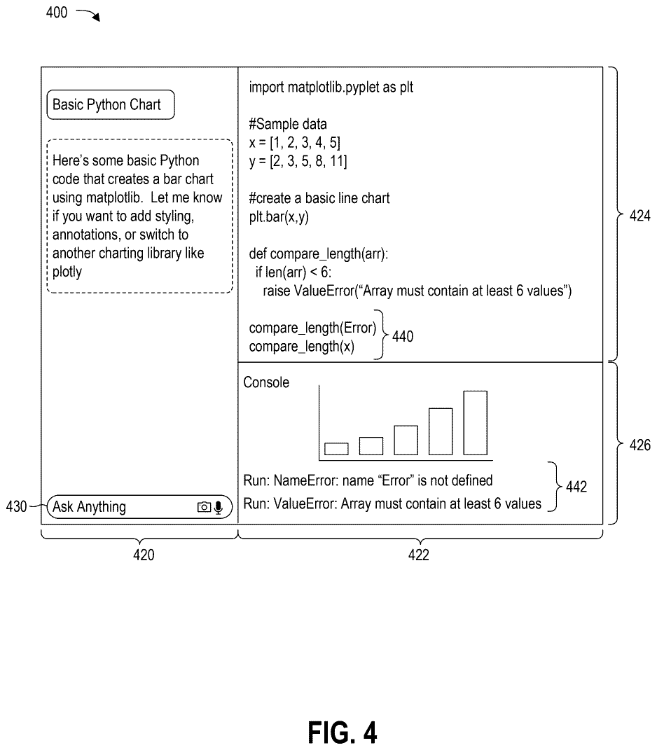

FIG. 4 is an illustration of a development application 400 and thrown exceptions logged into a console in accordance with some aspects of the disclosure. For example, FIG. 4 illustrates a collaborative interface that allows input from human users and the generative response engine (an example of which is CANVAS from OPENAI) that is used by a generative response engine such as CHATGPT to develop an interactive application (e.g., bespoke application 230). The development application 400 includes a side area 420 (e.g., a <div> positioned in a left column of a browser's viewport) and a main area 422. The main area 422 includes a code area 424 for editing code and a console 426 for displaying output. In this example, development application 400 is configured to address a single script file in Python to perform various functions. Development application 400 can include more complex structures, such as a project that is compiled into bytecode or a project that is transpiled into various types of application bundles.

The side area 420 includes a prompt input 430 that is configured to receive multimodal input (e.g., text, voice, images) and allow interaction with the generative response engine. In this example, a simple project is scaffolded from a template, and the generative response engine is configured to install an external library (matplotlib.pyplet) using a package manager (e.g., pip for python) and generate sample code to display a bar chart. In some aspects, development application 400 is configured to provide useful information to console 426, such as the output of the plot command (plt.bar(x,y)).

The development application 400 also includes instructions 440 that are provided for illustrative purposes that invoke an error. A function for comparing a length of an array (compare_length) determines if a length is at least 6 characters and throws an exception if the length is less than six. The first instruction 440 attempts to compare a value that is not defined (Error), which causes a NameError to be displayed in console 426 at region 442. The second instruction 440 attempts to compare the x array, which throws the ValueError shown in region 442.

In some aspects, console 426 shows an error for illustrative purposes. A stack trace is a report that shows the sequence of function calls that led to an error in a program and identifies the locations of a function that was called. For example, each line in the stack trace typically shows a function name, file, and line number, starting from where the error occurred and tracing back through the call hierarchy. The stack trace is a trail of information that can be used by developers to trace where exactly an error occurred in the code. Table 2 illustrates an example stack trace that illustrates an error that occurred because a function formatName tried to call .toUpperCase( ) on a value that was undefined, which is a particular type in JavaScript that has not been initialized.

```
TABLE 2
TypeError: Cannot read property ‘toUpperCase’ of undefined
  at formatName (/app/utils.js:10:18)
  at greetUser (/app/main.js:5:15)
  at Object.<anonymous> (/app/main.js:12:1)
  at Module._compile (modules/cjs/loader.js:1063:30)
  at Object.Module._extensions..js (/modules/cjs/loader.js:1092:10)
  at Module.load (modules/cjs/loader.js:928:32)
  at Function.Module._load (modules/cjs/loader.js:769:14)
  at Function.executeUserEntryPoint [as runMain] (.../run_main.js:72:12)
  at internal/main/run_main_module.js:17:47
```

In some aspects, development application 400 can be configured to be inspected by a debug engine (e.g., debug engine 240) that operates in conjunction with the chat interface (e.g., prompt input 430) to debug problems that are introduced by the user and the generative response engine. For example, the debug engine can detect thrown exceptions and provide a stack trace of the exception to the generative response engine with at least a portion of the code of development application 400 to identify solutions to the thrown exceptions.

In some aspects, there may be multiple reasons for the error and the generative response engine can be used to identify at least one solution. For example, the error in Table 2 can be fixed by adding a null coalescing operator (e.g., formatName?.toUppercase( )). The error in Table 2 can also be addressed based on the type provided to the formatName function or the greetUser function. For example, if an integer (e.g., a number type in javascript) was provided to the formatName function or the greetUser function, the stack trace in FIG. 2 could occur.

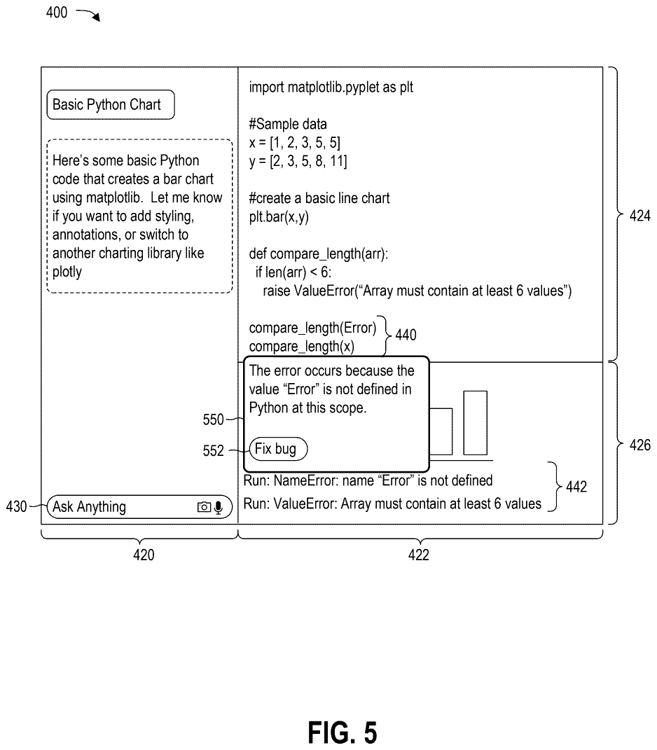

FIG. 5 is an illustration of a development application and an interface to resolve thrown exceptions using a generative response engine in accordance with some aspects of the disclosure. In particular, FIG. 5 illustrates application 400 and corresponding features (e.g., side area 420, code area 424, console 426, prompt input 430, etc.). In some aspects, a debug engine (e.g., debug engine 240) is configured to monitor console 426, identify a thrown exception (e.g., in region 442), and perform initial debugging operations using a generative response engine.

In some aspects, the debug engine is configured to display an interface 550 that explains in natural language that is more expressive than the specific facts of a stack trace. For example, interface 550 displays that the value Error, which is input into first instruction 440, is not defined. While a conventional stack trace displays some information, the explanation is technical and can potentially confuse a novice. Generative response engine interface 550 formats a well-formed response and then causes development application 400 (e.g., with the debug engine) to display interface 550 using various techniques (e.g., portals, the pop-up window API, etc.).

Interface 550 may also include a control 552 to instruct the debug engine to attempt to resolve the exception using the generative response engine. For example, the generative response engine provides information that can address the error. As noted above, there can be multiple techniques to resolve the error, and that error can occur in regions that are not identified by the stack trace. In the event that a user engages control 552 (e.g., via a click), development application 400 is configured to send information to the generative response engine to address the error, receive a patch that addresses the issue, and promulgate that patch into the interactive application associated with development application 400.

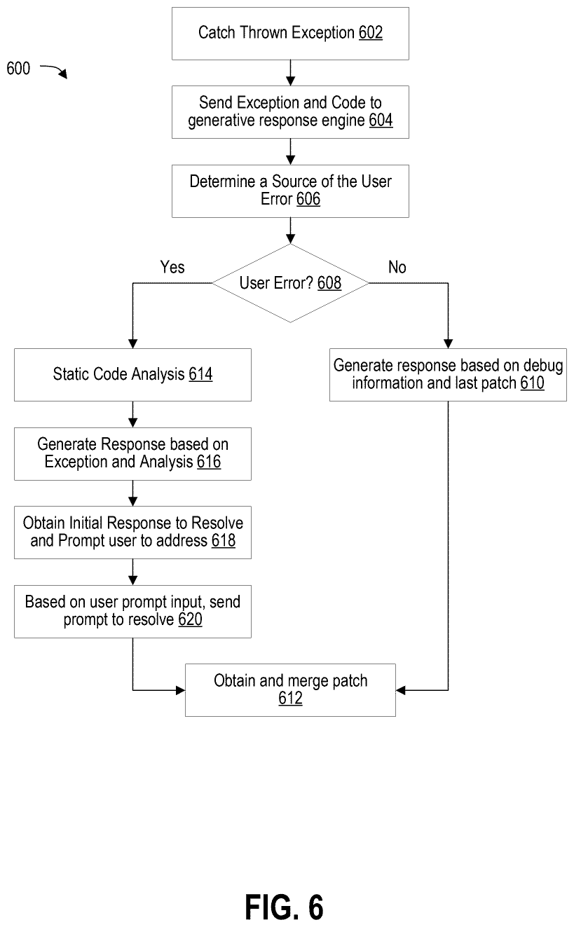

FIG. 6 is a flow diagram of a process 600 for assisted debugging using a generative response engine in accordance with some aspects of the disclosure. In some aspects, process 600 is performed at a computing device (e.g., a user laptop, etc.) and a generative response engine (e.g., generative response engine 110). Process 600 can also be at least partially performed on a server based on the application architecture. In some aspects, the process 600 is performed by the front end application 220 and the debug engine 240 in FIG. 2.

At block 602, the computing device catches a thrown exception at block 602. For example, a thrown exception can be identified in various ways. In one example, the thrown exception can be logged to a console and the error can be identified from the console. In another example, the application can be configured in a try/catch block of code (e.g., Table 1) and the instructions of the application (e.g., front end application 220) can catch the exception for further processing (e.g., in the catch block).

At block 604, the process sends a debug prompt to the generative response engine. In some aspects, the computing device may try to provide as much contextual information about the user code and what the error is and then format the error so that the model can understand where the code is happening. In some cases, a stack trace with line numbers is not comprehensible to a generative response engine based on a line number. At block 604, the debug prompt can include a map that maps line numbers in the stack trace to features in the user code that is included in the debug prompt. For example, in some cases the debug prompt can structure the code using a lightweight JSON model that explicitly maps line numbers to the text (e.g., {line: number, text: string}), or other features or symbols can be inserted into the code itself (e.g., a special comment to annotate a source of error to the generative response engine). The computing device may send the code, the debug prompt, and any additional context that would help the generative response engine to understand the problem. In some cases, the stack trace is also formatted to map its content to the code (e.g., a special comment, etc.). The additional annotation assists the generative response engine in identifying a source of the error based on the suitable context.

At block 606, the process (e.g., at the generative response engine) can detect a source of the change that causes the thrown exception. For example, based on code applied in the latest patch, the application throws the exception. In some cases, the computing device can use a dependency graph and other compiling information to identify errors and their source. For example, if a function that was previously available becomes unavailable, a syntax error created by a user may be causing the problem.

At block 608, the process determines if the error was generated based on user input. For example, if the error was not generated by user error, the process generates a debug prompt and provides the debug prompt to the generative response engine at block 610 to resolve the errors. In this case, the generative response can use the context of the patch, the previous prompt, and the debug prompt to identify the error. In some cases, the additional context based on the original prompt that caused the error can cause the generative response engine to reason to resolve the error.

At block 612, the computing device obtains a patch from the generative response engine based on the debug prompt at block 610 and merges the patch. In this way, errors that are introduced by the generative response engine are identified without user input and with additional context based on the initial prompt. The generative response engine can reason to identify a solution based on all the provided information.

Returning to block 608, if the error is input by the user, the process continues to block 614 to perform a static analysis of the user code. A static analysis examines code without executing the code to detect errors, enforce coding standards, and infer structural or semantic information. For example, a static analysis typically involves syntax checking to ensure the code is valid, type inference and checking to catch mismatches or undefined variables, and scope analysis to verify that identifiers are properly declared and used. Static analysis also includes linting for style enforcement, control flow and data flow analysis to detect unreachable code or security vulnerabilities, and inspection of dependencies to ensure proper module usage. Additionally, static analysis can identify code smells (e.g., identify patterns that are usually bugs), assess complexity metrics, and highlight patterns that commonly lead to bugs to help improve code quality, security, and maintainability.

At block 616, the process generates a prompt based on the exception, debug information and the analysis from block 614. The debug information is content from the exception that is mapped into a form that is comprehensible to the generative response engine. A stack trace with line numbers is not comprehensible to a generative response engine since the generative response engine does not count line numbers, and mapped information can be used to map line numbers to the stack track. For example, in some cases the debug prompt can structure the code using a lightweight JSON model that explicitly maps line numbers to the text (e.g., {line: number, text: string}), or other features or symbols can be inserted into the code itself (e.g., a special comment to annotate a source of error to the generative response engine). The stack trace is also formatted to map its content to the code (e.g., a special comment, etc.). The process may send the code, the debug information, the static analysis, and any additional context that would help the generative response engine to understand the problem. In some aspects, block 616 can be performed at a server and/or a client. For example, the client device can generate the debug information before block 616 and provide it with the initial prompt.

At block 618, the process obtains a response from the generative prompt engine including a suggestion to resolve the thrown exception, and may prompt a user to address the exception. In this case, the response is provided to a computing device of a user, which can display a prompt (e.g., interface 550) to request permission to address. The response at block 618 includes a potential solution to the error introduced by the user that causes the exception.

At block 620, the process receives user input (e.g., by clicking control 552) and formats a prompt based on the prior response. In some aspects, the process provides all the information including the code, the error, and the suggestion. Based on the suggestion and all the previous information, the generative response engine performs inference similar to a reasoning step to the model since it has already looked at the error in the code, and seeing the error and the suggestion a second time provides a reinforcement mechanism to improve the response. In some aspects, the additional inference step can provide a better response than a single response because the hint (e.g., in the suggestion from the initial response) can steer the error analysis on the second inference.

The process proceeds to block 612 and obtains a response including a patch based on the prompt from block 620. The process merges the patch and makes the updated code available to the computing device.

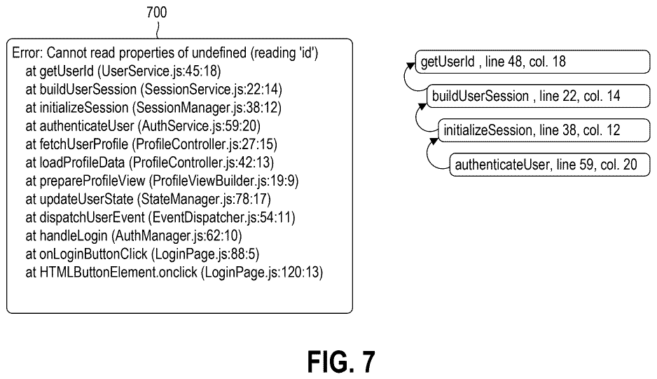

FIG. 7 is a conceptual illustration of a stack trace 700 provided by a thrown exception illustrating mapping data in accordance with some aspects of the disclosure. The stack trace 700 identifies the order of called function in a stack including a line number and a column. The stack trace 700 illustrates a stack provided by JavaScript. Other languages are similar, but details can vary based on language features, options, and so forth. The illustration depicts authenticateUser calling initializeSession, which calls buildUserSession, which then calls getUserId. With this context, the generative response engine can identify different aspects of the application to investigate to identify potential sources of problems.

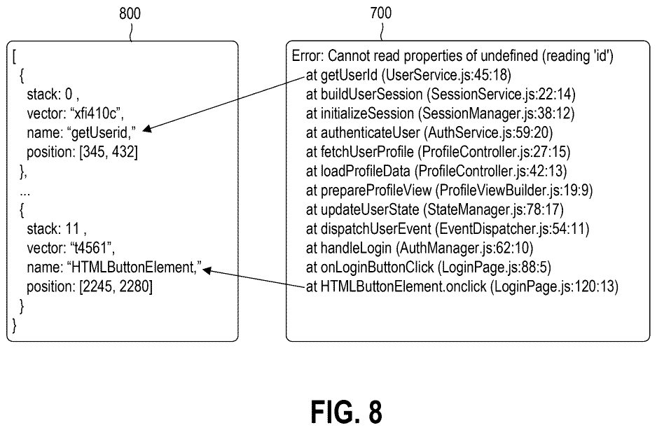

FIG. 8 is a conceptual diagram illustrating mapping a thrown exception to features in a debug prompt in accordance with some aspects of the disclosure. The example illustrated in FIG. 8 uses stack trace 700 to generate a map 800 that maps features from stack trace 700 into a form that the generative response engine can understand based code it receives and understands. For example, the generative response engine may convert each unique item in code into a representation within a vector domain, and map 800 can be used by the generative response engine to understand stack trace 700 in its domain.

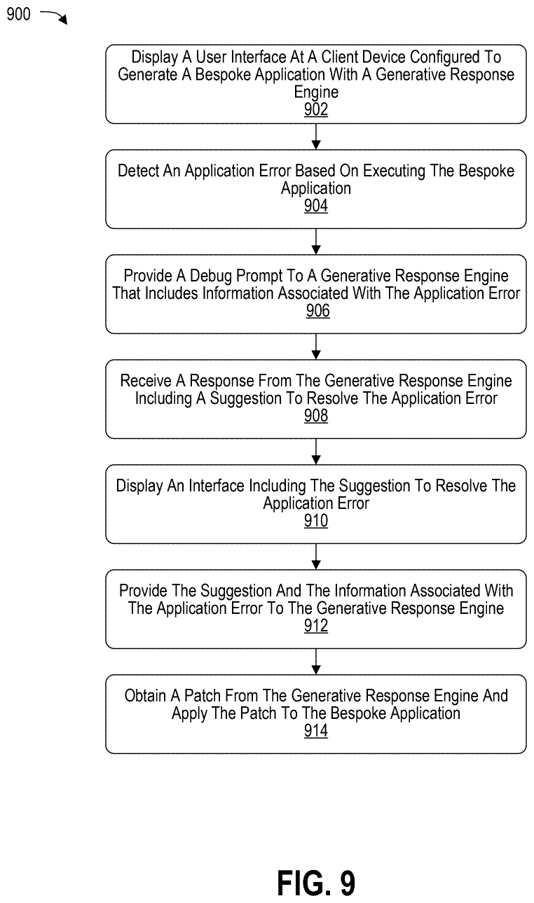

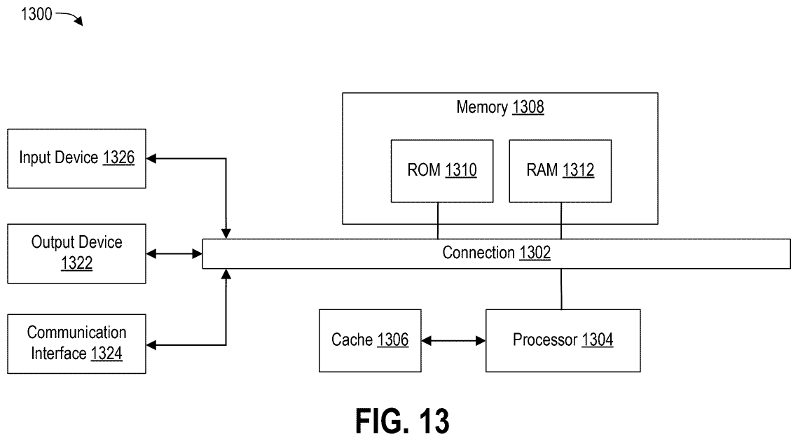

FIG. 9 is a flow diagram of a process 900 for assisted debugging using a generative response engine in accordance with some aspects of the disclosure. Process 900 can be performed by a computing device (or apparatus) or a component (e.g., one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of process 900 may be implemented as software components that are executed and run on one or more processors (e.g., CPU, GPU, DSP, NPU or neural engine, SoC, processor 1304 of FIG. 13, and/or other processor(s)). In some aspects, a computing device may connect to a cloud computing service including a generative response engine (e.g., generative response engine 210 in FIG. 2) to execute various tasks. In some cases, the computing device can be based on a mixed application configuration (e.g., a client and a server) that work in coordination to generate information. In some cases in process 900, the computing device can be a server of the generative response engine for some blocks, and a client device for other blocks.

At block 902, the computing device may display a user interface configured to generate a bespoke application with a generative response engine.

At block 904, the computing device may detect an application error based on executing the bespoke application. The application error includes a stack trace with line numbers identifying a call order of functions of the bespoke application. For example, the application may be a thrown application error, and may be caught in a try/catch block. In other example, the application error can be detected based on a console (e.g., STDERR).

At block 906, the computing device may provide a debug prompt to a generative response engine that includes information associated with the application error. The information associated with the application error can include the stack trace, which can be provided in various ways. For example, the computing device can identify at least the line numbers associated with the application error and map the line numbers to features within instructions associated with at least one function in the call order. The debug prompt may include a structured input that identifies the line numbers to the at least one function in the call order.

The debug prompt can also include instructions associated with at least one function in the call order. For example, the debug prompt may include an attachment with the code that allows the generative response engine to analyze the instructions.

In some aspects, the computing device may perform a static analysis on a first portion of the bespoke application generating the application error. The static analysis includes at least one of a syntax analysis, type analysis, a scope analysis, a lint analysis, a control flow analysis, a data flow analysis, a dependency analysis, and a code pattern analysis. In some cases, the static analysis is premised on a user-introduced error.

At block 908, the computing device may receive a response from the generative response engine including a suggestion to resolve the application error.

At block 910, the computing device may display an interface including the suggestion to resolve the application error. In some aspects, the interface may be a popup or a hover card that renders based on a delay after hovering. The computing device may receive an input in the interface to request the generative response engine to resolve the application error.

At block 912, the computing device may provide the suggestion and the information associated with the application error to the generative response engine. In this context, the suggestion operates as a hint and the generative engine is able to provide a better solution based on the additional context.

At block 914, the computing device may obtain a patch from the generative response engine and apply the patch to the bespoke application. For example, the computing device may apply the patch to the bespoke application to trigger a module replacement and reinitialize the bespoke application without the application error. For example, the bespoke application includes a first state before the application error and the first state after applying the patch, with the first state being state information of the bespoke application. That is, even though an error is introduced, state is maintained.

In some aspects, process 900 may operate differently based on a source of the error. For example, the computing device may determine whether a source of the application error corresponds to a user change or generative response engine change. When the source of the application error corresponds to the generative response engine change, the computing device may send a first patch corresponding to the source of the application error to the generative response engine. The first patch includes information previously sent to the computing device by the generative response engine (e.g., a previous patch that created the error). The computing device may apply a second patch received from the generative response engine to resolve the application error.

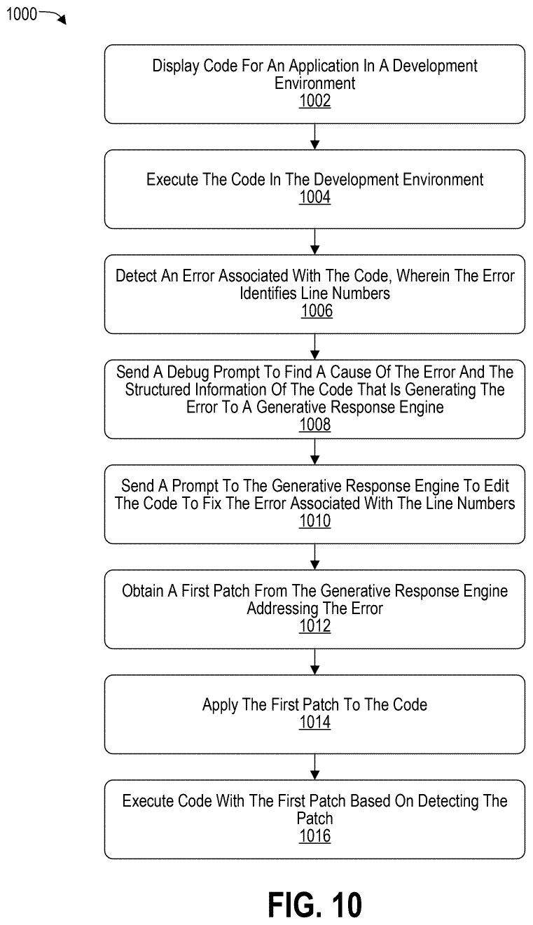

FIG. 10 is a flow diagram of a process 1000 for assisted debugging using a generative response engine in accordance with some aspects of the disclosure. The process 1000 can be performed by a computing device (or apparatus) or a component (e.g., one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of process 1000 may be implemented as software components that are executed and run on one or more processors (e.g., CPU, GPU, DSP, NPU or neural engine, SoC, processor 1304 of FIG. 13, and/or other processor(s)). In some aspects, a computing device may connect to a cloud computing service including a generative response engine (e.g., generative response engine 210 in FIG. 2) to execute various tasks.

At block 1002, the computing device may display code for an application within a development environment. The displayed code serves as the working copy that a user can review, edit, and execute within the environment. The input to this block is source code provided by the user or an associated repository, and the output is the rendered code within the graphical interface of the development environment for user interaction.

At block 1004, the computing device may execute the code within the development environment. The goal of executing the code is to identify whether the code performs as expected or contains errors. The input to this block is the code rendered from block 902, and the output is runtime behavior, which may include successful operation or error generation.

At block 1006, the computing device may detect an error associated with the code during execution, wherein the error identifies one or more line numbers corresponding to the source of the error within the displayed code. Detection of the error involves capturing exception information, stack traces, and diagnostic data associated with execution failure. The output includes the line numbers, error type, and optionally a descriptive message useful for troubleshooting.

At block 1008, the computing device may send a debug prompt to a generative response engine, along with structured information regarding the code that generated the error, wherein the structured information includes a mapping of the identified line numbers to features referenced within the debug prompt. The goal of this block is to provide the generative response engine with sufficient context to reason about the code failure. The input includes the debug prompt text, the error data, and the structured mapping, and the output is the query delivered to the generative response engine for analysis.

At block 1010, the computing device may send a further prompt to the generative response engine instructing the engine to edit the code to correct the error associated with the identified line numbers. The second prompt provides explicit instructions for code repair rather than diagnostic analysis, and the input includes the original code fragment, error mapping, and instructions to propose modifications. The output is a request pending a code patch response from the generative response engine.

At block 1012, the computing device may obtain a first patch from the generative response engine, wherein the first patch addresses the detected error and proposes one or more modifications to the code. The patch may include insertions, deletions, or updates aligned to the mapped line numbers. The input to this block is the response from the generative engine, and the output is a structured set of code changes intended to resolve the identified error.

At block 1014, the computing device may apply the first patch to the code displayed within the development environment, updating the code to include the modifications proposed by the generative response engine. Application of the patch modifies the user's working copy to incorporate the suggested corrections, and the output of this block is an updated codebase ready for re-execution.

At block 1016, the computing device may, based on detecting the application of the patch, execute the modified code incorporating the first patch. Execution of the patched code enables validation of whether the error has been resolved and whether the application behaves as intended. The input to this block is the modified code, and the output is the runtime behavior of the updated application.

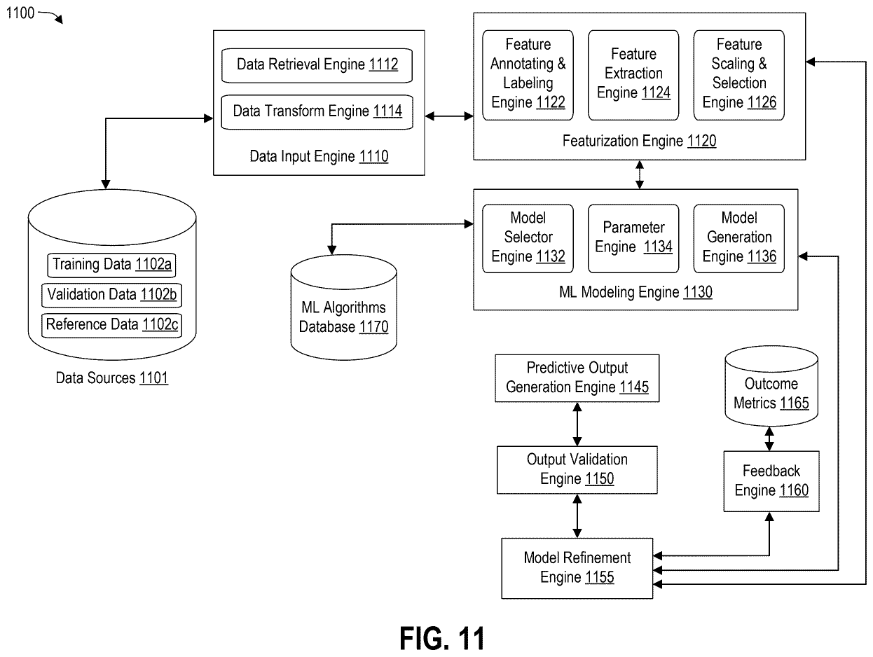

FIG. 11 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 1100 may include data input engine 1110 that can further include data retrieval engine 1112 and data transform engine 1114. Data retrieval engine 1112 may be configured to access, interpret, request, or receive data, which may be adjusted, reformatted, or changed (e.g., to be interpretable by another engine, such as data input engine 1110). For example, data retrieval engine 1112 may request data from a remote source using an API. Data input engine 1110 may be configured to access, interpret, request, format, re-format, or receive input data from data sources(s) 1101. For example, data input engine 1110 may be configured to use data transform engine 1114 to execute a re-configuration or other change to data, such as a data dimension reduction. In some aspects, data sources(s) 1101 may be associated with a single entity (e.g., organization) or with multiple entities. Data sources(s) 1101 may include one or more of training data 1102a (e.g., input data to feed a machine learning model as part of one or more training processes), validation data 1102b (e.g., data against which at least one processor may compare model output with, such as to determine model output quality), and/or reference data 1102c. In some aspects, data input engine 1110 can be implemented using at least one computing device. For example, data from data sources(s) 1101 can be obtained through one or more I/O devices and/or network interfaces. Further, the data may be stored (e.g., during execution of one or more operations) in a suitable storage or system memory. Data input engine 1110 may also be configured to interact with a data storage, which may be implemented on a computing device that stores data in storage or system memory.

System 1100 may include featurization engine 1120. Featurization engine 1120 may include feature annotating & labeling engine 1122 (e.g., configured to annotate or label features from a model or data, which may be extracted by feature extraction engine 1124), feature extraction engine 1124 (e.g., configured to extract one or more features from a model or data), and/or feature scaling & selection engine 1126 Feature scaling & selection engine 1126 may be configured to determine, select, limit, constrain, concatenate, or define features (e.g., AI features) for use with AI models.

System 1100 may also include machine learning (ML) ML modeling engine 1130, which may be configured to execute one or more operations on a machine learning model (e.g., model training, model re-configuration, model validation, model testing), such as those described in the processes described herein. For example, ML modeling engine 1130 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 1102a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 1130 may include model selector engine 1132 (e.g., configured to select a model from among a plurality of models, such as based on input data), parameter engine 1134 (e.g., configured to add, remove, and/or change one or more parameters of a model), and/or model generation engine 1136 (e.g., configured to generate one or more machine learning models, such as according to model input data, model output data, comparison data, and/or validation data).

In some aspects, model selector engine 1132 may be configured to receive input and/or transmit output to ML algorithms database 1170. Similarly, featurization engine 1120 can utilize storage or system memory for storing data and can utilize one or more I/O devices or network interfaces for transmitting or receiving data. ML algorithms database 1170 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 1170 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 1170 include versions DALL-E, CHAT GPT, and SORA, all provided by OPEN AI.

System 1100 can further include predictive output generation engine 1145 and output validation engine 1150 (e.g., configured to apply validation data to machine learning model output). Predictive output generation engine 1145 can analyze the input and identify relevant patterns and associations in the data it has learned to generate a sequence of words that predictive output generation engine 1145 predicts is the most likely continuation of the input using one or more models from the ML algorithms database 1170, aiming to provide a coherent and contextually relevant answer. Predictive output generation engine 1145 generates responses by sampling from the probability distribution of possible words and sequences, guided by the patterns observed during its training. In some aspects, predictive output generation engine 1145 can generate multiple possible responses before presenting the final one. Predictive output generation engine 1145 can generate multiple responses based on the input, and these responses are variations that predictive output generation engine 1145 considers potentially relevant and coherent. Output validation engine 1150 can evaluate these generated responses based on certain criteria. These criteria can include relevance to the prompt, coherence, fluency, and sometimes adherence to specific guidelines or rules, depending on the application. Based on this evaluation, output validation engine 1150 selects the most appropriate response. This selection is typically the one that scores highest on the set criteria, balancing factors like relevance, informativeness, and coherence.

System 1100 can further include feedback engine 1160 (e.g., configured to apply feedback from a user and/or machine to a model) and model refinement engine 1155 (e.g., configured to update or re-configure a model). In some aspects, feedback engine 1160 may receive input and/or transmit output (e.g., output from a trained, partially trained, or untrained model) to outcome metrics database 1165. Outcome metrics database 1165 may be configured to store output from one or more models and may also be configured to associate output with one or more models. In some aspects, outcome metrics database 1165, or other device (e.g., model refinement engine 1155 or feedback engine 1160), may be configured to correlate output, detect trends in output data, and/or infer a change to input or model parameters to cause a particular model output or type of model output. In some aspects, model refinement engine 1155 may receive output from predictive output generation engine 1145 or output validation engine 1150. In some aspects, model refinement engine 1155 may transmit the received output to featurization engine 1120 or ML modeling engine 1130 in one or more iterative cycles.

The engines of system 1100 may be packaged functional hardware units designed for use with other components or a part of a program that performs a particular function (e.g., of related functions). Any or each of these modules may be implemented using a computing device. In some aspects, the functionality of system 1100 may be split across multiple computing devices to allow for distributed processing of the data, which may improve output speed and reduce computational load on individual devices. In some aspects, system 1100 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 1100 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

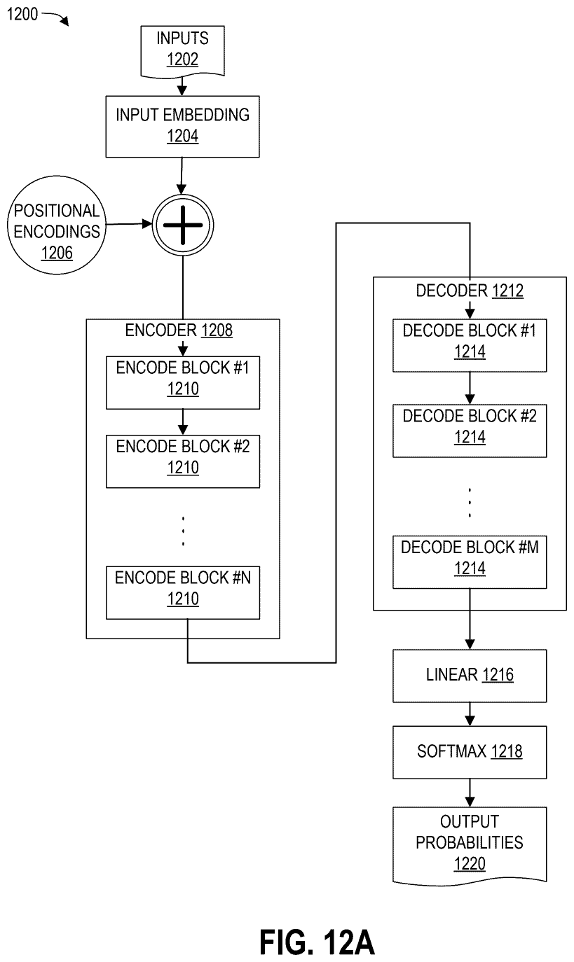

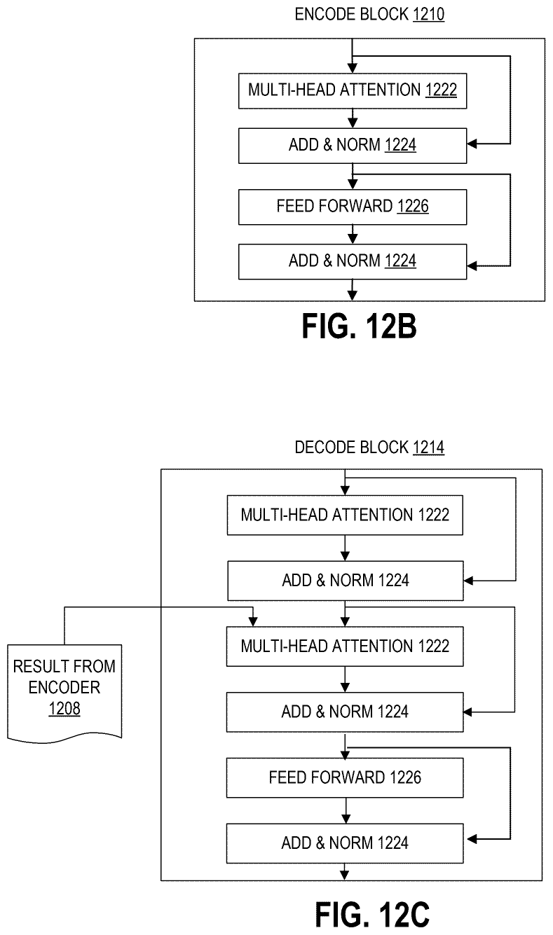

FIG. 12A, FIG. 12B, and FIG. 12C illustrates an example transformer architecture in accordance with some aspects of the present technology. Examples of ML models that use a transformer neural network (e.g., transformer architecture 1200) can include, e.g., generative pretrained transformer (GPT) models and Bidirectional Encoder Representations from Transformer (BERT) models. The transformer architecture 1200, which is illustrated in FIG. 12A, FIG. 12B, and FIG. 12C, includes inputs 1202, input embedding block 1204, positional encodings 1206, encoder 1208 including encode blocks 1210, decoder 1212 including decode blocks 1214, linear block 1216, softmax block 1218, and output probabilities 1220.

Input embedding block 1204 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 1204 can be learned embeddings to convert the input tokens and output tokens to vectors of dimension that have the same dimension as the positional encodings, for example.

Positional encodings 1206 provide information about the relative or absolute position of the tokens in the sequence. According to certain non-limiting examples, positional encodings 1206 can be provided by adding positional encodings to the input embeddings at the inputs to the encoder 1208 and decoder 1212. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 1208 can use stacked self-attention and point-wise, fully connected layers. Encoder 1208 can be a stack of N identical layers (e.g., N=6), and each layer can be an encode block, as illustrated by encode block 1210 shown in FIG. 12B. Each encode block 1210 has two sub-layers: (i) a first sub-layer has a multi-head attention block 1222 and (ii) a second sub-layer has a feed forward block 1226, which can be a position-wise fully connected feed-forward network. The feed forward block 1226 can use a rectified linear unit (ReLU).

Encoder 1208 uses a residual connection around each of the two sub-layers, followed by an add & norm block 1224, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 1208, decoder 1212 uses stacked self-attention and point-wise, fully connected layers. Decoder 1212 can also be a stack of M identical layers (e.g., M=6), and each layer can be a decode block, as illustrated by decoder 1212 shown in FIG. 12B. In addition to the two sub-layers (i.e., the sublayer with multi-head attention block 1222 and the sub-layer with feed forward block 1226) found in encode block 1210, decode block 1214 can include a third sub-layer, which performs multi-head attention over the output of the encoder stack. Similar to encoder 1208, decoder 1212 uses residual connections around each of the sub-layers, followed by layer normalization. Additionally, the sub-layer with multi-head attention block 1222 can be modified in the decoder stack to prevent positions from attending to subsequent positions. This masking, combined with the fact that the output embeddings are offset by one position, can ensure that the predictions for position i can depend on the known output data at positions less than i.

Linear block 1216 can be a learned linear transformation. For example, when transformer architecture 1200 is being used to translate from a first language into a second language, linear block 1216 can project the output from the last decode softmax block 1218 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 1218 then turns the scores from linear block 1216 into output probabilities 1220 (which add up to 1.0). In each position, the index provides for the word with the highest probability, and then maps that index to the corresponding word in the vocabulary. Those words then form the output sequence of transformer architecture 1200. The softmax operation is applied to the output from linear block 1216 to convert the raw numbers into output probabilities 1220 (e.g., token probabilities).

FIG. 13 shows an example of computing system 1300, which can be, For example, any computing device making up any engine illustrated in FIG. 1 or any component thereof.

In some aspects, computing system 1300 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 1300 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1300 includes at least one processing unit (CPU or processor) 1304 and connection 1302 that couples various system components including system memory 1308, such as read-only memory (ROM) 1310 and random access memory (RAM) 1312 to processor 1304. Memory 1308 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 1308 can include software services, servers, logic, etc., that when the code that defines such software is executed by the processor 1304, it causes the system to perform a function. In some aspects, a hardware service that performs a particular function can include the software component stored in a computer-readable medium in connection with the necessary hardware components, such as processor 1304, connection 1302, output device 1322, etc., to carry out the function.

Computing system 1300 can include a cache of high-speed memory 1306 connected directly with, in close proximity to, or integrated as part of processor 1304.

Connection 1302 can be a physical connection via a bus, or a direct connection into processor 1304, such as in a chipset architecture. Connection 1302 can also be a virtual connection, networked connection, or logical connection.

Processor 1304 can include any general purpose processor and a hardware service or software service stored in memory 1308, configured to control processor 1304 as well as a special-purpose processor where software instructions are incorporated into the actual processor design. Processor 1304 may be a completely self-contained computing system, containing multiple cores or processors, a bus, memory controller, cache, etc. A multi-core processor may be symmetric or asymmetric. Processor 1304 can be physical or virtual.

To enable user interaction, computing system 1300 includes an input device 1326, which can represent any number of input mechanisms, such as a microphone for speech, a touch-sensitive screen for gesture or graphical input, keyboard, mouse, motion input, speech, etc. Computing system 1300 can also include output device 1322, which can be one or more of a number of output mechanisms known to those of skill in the art. In some instances, multimodal systems can enable a user to provide multiple types of input/output to communicate with computing system 1300. Computing system 1300 can include communication interface 1324, which can generally govern and manage the user input and system output. There is no restriction on operating on any particular hardware arrangement, and therefore the basic features here may easily be substituted for improved hardware or firmware arrangements as they are developed.

In some aspects, computing system 1300 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

The present technology includes computer-readable storage mediums for storing instructions, and systems for executing any one of the methods embodied in the instructions addressed in the aspects of the present technology presented below:

Aspect 1. A method, comprising: displaying a user interface at a client device configured to generate a bespoke application with a generative response engine; detecting an application error based on executing the bespoke application, wherein the application error includes a stack trace with line numbers identifying a call order of functions of the bespoke application; providing a debug prompt to a generative response engine that includes information associated with the application error; receiving a response from the generative response engine including a suggestion to resolve the application error; and displaying an interface including the suggestion to resolve the application error.

Aspect 2. The method of Aspect 1, further comprising: identifying at least the line numbers associated with the application error; and mapping the line numbers to features within instructions associated with at least one function in the call order, wherein the debug prompt includes a structured input that identifies the line numbers to the at least one function in the call order.

Aspect 3. The method of any of Aspects 1 to 2, further comprising: determining whether a source of the application error corresponds to a user change or generative response engine change.

Aspect 4. The method of Aspect 3, further comprising: when the source of the application error corresponds to the generative response engine change, sending a first patch corresponding to the source of the application error to the generative response engine, wherein the first patch includes information previously sent to the client device by the generative response engine; and applying a second patch received from the generative response engine to resolve the application error.

Aspect 5. The method of any of Aspects 3 to 4, further comprising: when the source of the application error corresponds to the user change, performing a static analysis on a first portion of the bespoke application generating the application error.

Aspect 6. The method of Aspect 5, wherein the static analysis includes at least one of a syntax analysis, type analysis, a scope analysis, a lint analysis, a control flow analysis, a data flow analysis, a dependency analysis, and a code pattern analysis.

Aspect 7. The method of any of Aspects 1 to 6, further comprising: based on input into the user interface, provide the suggestion and the information associated with the application error to the generative response engine.

Aspect 8. The method of any of Aspects 1 to 7, wherein the debug prompt includes instructions associated with at least one function in the call order.

Aspect 9. The method of any of Aspects 1 to 8, wherein the error comprises a thrown exception.

Aspect 10. The method of Aspect 9, further comprising: catching the thrown exception.

Aspect 11. The method of Aspect 10, further comprising: applying a patch to the bespoke application to trigger a module replacement and reinitialize the bespoke application without the application error.

Aspect 12. The method of Aspect 11, wherein the bespoke application includes a first state before the application error and the first state after applying the patch.

Aspect 13. The method of any of Aspects 1 to 12, further comprising: receiving an input in the interface to request the generative response engine to resolve the application error.

Aspect 14. A method comprising: displaying code for an application in a development environment; executing the code in the development environment; detecting an error associated with the code, wherein the error identifies line numbers; sending a debug prompt to find a cause of the error and the structured information of the code that is generating the error to a generative response engine, wherein the structured information maps the line numbers of the code to features in the debug prompt; sending a prompt to the generative response engine to edit the code to fix the error associated with the line numbers; obtaining a first patch from the generative response engine addressing the error; applying the first patch to the code; based on detecting the patch, executing code with the first patch.

Aspect 15. A computing device, comprising: at least one memory; and at least one processor coupled to the at least one memory and configured to: display a user interface at a client device configured to generate a bespoke application with a generative response engine; detect an application error based on executing the bespoke application, wherein the application error includes a stack trace with line numbers identifying a call order of functions of the bespoke application; provide a debug prompt to a generative response engine that includes information associated with the application error; receive a response from the generative response engine including a suggestion to resolve the application error; and display an interface including the suggestion to resolve the application error.

Aspect 16. The computing device of Aspect 15, wherein the at least one processor is configured to: identify at least the line numbers associated with the application error; and map the line numbers to features within instructions associated with at least one function in the call order, wherein the debug prompt includes a structured input that identifies the line numbers to the at least one function in the call order.

Aspect 17. The computing device of any of Aspects 15 to 16, wherein the at least one processor is configured to: determine whether a source of the application error corresponds to a user change or generative response engine change.

Aspect 18. The computing device of Aspect 17, wherein the at least one processor is configured to: when the source of the application error corresponds to the generative response engine change, send a first patch corresponding to the source of the application error to the generative response engine, wherein the first patch includes information previously sent to the client device by the generative response engine; and apply a second patch received from the generative response engine to resolve the application error.

Aspect 19. The computing device of any of Aspects 17 to 18, wherein the at least one processor is configured to: when the source of the application error corresponds to the user change, perform a static analysis on a first portion of the bespoke application generating the application error.

Aspect 20. The computing device of Aspect 19, wherein the static analysis includes at least one of a syntax analysis, type analysis, a scope analysis, a lint analysis, a control flow analysis, a data flow analysis, a dependency analysis, and a code pattern analysis.

Aspect 21. The computing device of any of Aspects 15 to 20, wherein the at least one processor is configured to: based on input into the user interface, provide the suggestion and the information associated with the application error to the generative response engine.

Aspect 22. The computing device of any of Aspects 15 to 21, wherein the debug prompt includes instructions associated with at least one function in the call order.

Aspect 23. The computing device of any of Aspects 15 to 22, wherein the error comprises a thrown exception.

Aspect 24. The computing device of Aspect 23, wherein the at least one processor is configured to: catch the thrown exception.

Aspect 25. The computing device of Aspect 24, wherein the at least one processor is configured to: apply a patch to the bespoke application to trigger a module replacement and reinitialize the bespoke application without the application error.

Aspect 26. The computing device of Aspect 25, wherein the bespoke application includes a first state before the application error and the first state after applying the patch.

Aspect 27. The computing device of any of Aspects 15 to 26, wherein the at least one processor is configured to: receive an input in the interface to request the generative response engine to resolve the application error.

Aspect 28. A computing device, comprising: at least one memory; and at least one processor coupled to the at least one memory and configured to: display code for an application in a development environment; execute the code in the development environment; detect an error associated with the code, wherein the error identifies line numbers; send a debug prompt to find a cause of the error and the structured information of the code that is generating the error to a generative response engine, wherein the structured information maps the line numbers of the code to features in the debug prompt; send a prompt to the generative response engine to edit the code to fix the error associated with the line numbers; obtain a first patch from the generative response engine addressing the error; apply the first patch to the code; based on detecting the patch, execute code with the first patch.

Aspect 29. A non-transitory computer-readable medium having stored thereon instructions that, when executed by at least one processor, cause the at least one processor to perform operations according to any of Aspects 1 to 13.

Aspect 30. An apparatus for performing a function, comprising one or more means for performing operations according to any of Aspects 1 to 13.

Aspect 31. A non-transitory computer-readable medium having stored thereon instructions that, when executed by at least one processor, cause the at least one processor to perform operations according to Aspect 14.

Aspect 32. An apparatus for performing a function, comprising one or more means for performing operations according to Aspect 14.

1. A method, comprising:
displaying a user interface at a client device configured to generate a bespoke application with a generative response engine;
detecting a runtime exception based on executing the bespoke application, wherein the runtime exception includes a stack trace identifying a call order of functions of the bespoke application and one or more line numbers corresponding to code lines of the bespoke application associated with the call order;
providing a debug prompt to the generative response engine that includes information associated with the runtime exception, wherein the debug prompt includes a structured input comprising the one or more line numbers, the code lines of the bespoke application corresponding to at least one of the one or more line numbers, and corresponding features identified in the stack trace;
receiving a response from the generative response engine including a suggestion to resolve the runtime exception; and
displaying an interface including the suggestion to resolve the runtime exception.

2. The method of claim 1, further comprising:
identifying at least the one or more line numbers associated with the runtime exception; and
mapping the one or more line numbers to the features within instructions associated with at least one function in the call order, wherein the structured input maps at least one of the one or more line numbers to the code lines of the bespoke application and to a respective feature in the stack trace.

3. The method of claim 1, further comprising determining whether a source of the runtime exception corresponds to a user change or a generative response engine change.

4. The method of claim 3, further comprising:
when the source of the runtime exception corresponds to the generative response engine change, sending a first patch corresponding to the source of the runtime exception to the generative response engine, wherein the first patch includes information previously sent to the client device by the generative response engine; and
applying a second patch received from the generative response engine based on the suggestion to resolve the runtime exception.

5. The method of claim 3, further comprising:
when the source of the runtime exception corresponds to the user change, performing a static analysis on a first portion of the bespoke application generating the runtime exception.

6. The method of claim 5, wherein the static analysis includes at least one of a syntax analysis, a type analysis, a scope analysis, a lint analysis, a control flow analysis, a data flow analysis, a dependency analysis, and a code pattern analysis.

7. The method of claim 1, further comprising:
based on an input into the user interface, providing the suggestion and the information associated with the runtime exception to the generative response engine.

8. The method of claim 1, wherein the debug prompt includes instructions associated with at least one function in the call order.

9. The method of claim 1, wherein the runtime exception comprises a thrown exception.

10. The method of claim 9, further comprising:
catching the thrown exception.

11. The method of claim 10, further comprising:
applying a patch to the bespoke application to trigger a module replacement and reinitialize the bespoke application without the runtime exception.

12. The method of claim 11, wherein the bespoke application includes a first state before the runtime exception and the first state after applying the patch.

13. The method of claim 1, further comprising:
receiving an input in the interface to request the generative response engine to resolve the runtime exception.

14. A method, comprising:
displaying code for an application in a development environment;
executing the code in the development environment;
detecting an error associated with the code, wherein the error identifies one or more line numbers associated with a stack trace;
sending a debug prompt to find a cause of the error and structured information of the code that is generating the error to a generative response engine, wherein the structured information includes the one or more line numbers, the code corresponding to at least one of the one or more line numbers, features in the debug prompt, and a structure that associates at least one of the one or more line numbers to a respective feature in the stack trace;
sending a prompt to the generative response engine to edit the code to fix the error associated with the one or more line numbers;
obtaining a first patch from the generative response engine addressing the error associated with the one or more line numbers;
applying the first patch to the code; and
executing the code with the first patch.

15. A computing device, comprising:
at least one memory; and
at least one processor coupled to the at least one memory and configured to:
display a user interface at a client device configured to generate a bespoke application with a generative response engine;
detect a runtime exception based on executing the bespoke application, wherein the runtime exception includes a stack trace identifying a call order of functions of the bespoke application, a substring associated with each line number, and one or more line numbers corresponding to code lines of the bespoke application associated with the call order;
provide a debug prompt to the generative response engine that includes information associated with the runtime exception, wherein the debug prompt includes a structured input comprising the one or more line numbers, the code lines of the bespoke application corresponding to at least one of the one or more line numbers, and corresponding features identified in the stack trace;
receive a response from the generative response engine including a suggestion to resolve the runtime exception; and
display an interface including the suggestion to resolve the runtime exception.

16. The computing device of claim 15, wherein the at least one processor is further configured to:
identify at least the one or more line numbers associated with the runtime exception; and
map the one or more line numbers to the features within instructions associated with at least one function in the call order of the bespoke application, wherein the structured input maps at least one of the one or more line numbers to the code lines of the bespoke application and to a respective feature in the stack trace.

17. The computing device of claim 15, wherein the at least one processor is further configured to:
determine whether a source of the runtime exception corresponds to a user change or a generative response engine change.

18. The computing device of claim 17, wherein the at least one processor is further configured to:
when the source of the runtime exception corresponds to the generative response engine change, send a first patch corresponding to the source of the runtime exception to the generative response engine, wherein the first patch includes information previously sent to the client device by the generative response engine; and
apply a second patch received from the generative response engine based on the suggestion to resolve the runtime exception.

19. The computing device of claim 17, wherein the at least one processor is further configured to:
when the source of the runtime exception corresponds to the user change, perform a static analysis on a first portion of the bespoke application generating the runtime exception.

20. The computing device of claim 19, wherein the static analysis includes at least one of a syntax analysis, a type analysis, a scope analysis, a lint analysis, a control flow analysis, a data flow analysis, a dependency analysis, and a code pattern analysis.
